(19) United States
(12) Patent Application Publication
(10) Pub. No.: US 2011/0006138 A1
(43) Pub. Date: Jan. 13, 2011

(54) RETENTION SYSTEM FOR ELASTOMERIC SPRAY NOZZLE RETAINER

(75) Inventors: Keith A. Christensen, Coon Rapids, MN (US); Thomas E. Pauly, Zimmerman, MN (US); Glen W. Davidson, Roseville, MN (US)

Correspondence Address: GRACO MINNESOTA INC, PO BOX 1441, MINNEAPOLIS, MN, 55440, US

(73) Assignee: GRACO MINNESOTA INC., Minneapolis, MN (US)

(21) Appl. No.: 12/827,589

(22) Filed: Jun. 30, 2010

Related U.S. Application Data
(60) Provisional application No. 61/223,580, filed on Jul. 7, 2009.

(51) Int. Cl. B05B 1/00

(52) U.S. Cl. 239/600

(57) ABSTRACT

A common method of retaining spray nozzles in texture applicators is to capture the nozzle by a rubber cap which is stretched over a retaining flange on the applicator's sprayhead. The effort required to stretch an elastomeric nozzle retainer (cap) 10 over the retaining flanges 12 on the sprayhead 14 is reduced by providing features facilitating the use of a prying tool 16 to amplify the user's effort. Flange relief flats 18 accommodate the natural, temporary inward deflection of the cap 10 during installation.

### TECHNICAL FIELD

This application claims the benefit of U.S. application Ser. No. 61/223,580, filed Jul. 7, 2009, the contents of which are hereby incorporated by reference.

### BACKGROUND ART

A common method of retaining spray nozzles in texture applicators is to capture the nozzle by a rubber cap which is stretched over a retaining flange on the applicator's sprayhead. This approach is fairly tolerant of texture residue contamination, and provides a pressure relief function since the cap and/or nozzle will be ejected from the sprayhead in overpressure situations. Stretching the cap onto the sprayhead is difficult as the flange must sufficiently engage the cap to develop adequate resistance to ejection, and installation is exacerbated when the parts are slippery with texture or water, requiring considerable user grip strength. As a compromise to these competing factors, makers of these applicators provide caps in several durometers and stiffnesses.

### DISCLOSURE OF THE INVENTION

The instant invention significantly reduces the effort required to stretch an elastomeric nozzle retainer (cap) over the retaining flanges on the sprayhead by providing features facilitating the use of a prying tool (e.g., screwdriver) to amplify the user's effort and flange relief flats which accommodate the natural, temporary inward deflection of the cap during installation. The large hole in the cap's tab, and the boss on the head, allow the user to anchor a tool on the boss, prying the cap into place with a very significant mechanical advantage (at least 300%).

The reliefs on the sides of the retaining flange provide clearance for the natural inwards deflection of the cap during installation. This makes the sprayhead appear ‘smaller’ to the cap during installation, yet the remaining flange still provides adequate retention once assembled. Also, the flats allow the user to push the cap somewhat farther onto the sprayhead when beginning the installation.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the start of the cap being applied to the sprayhead.

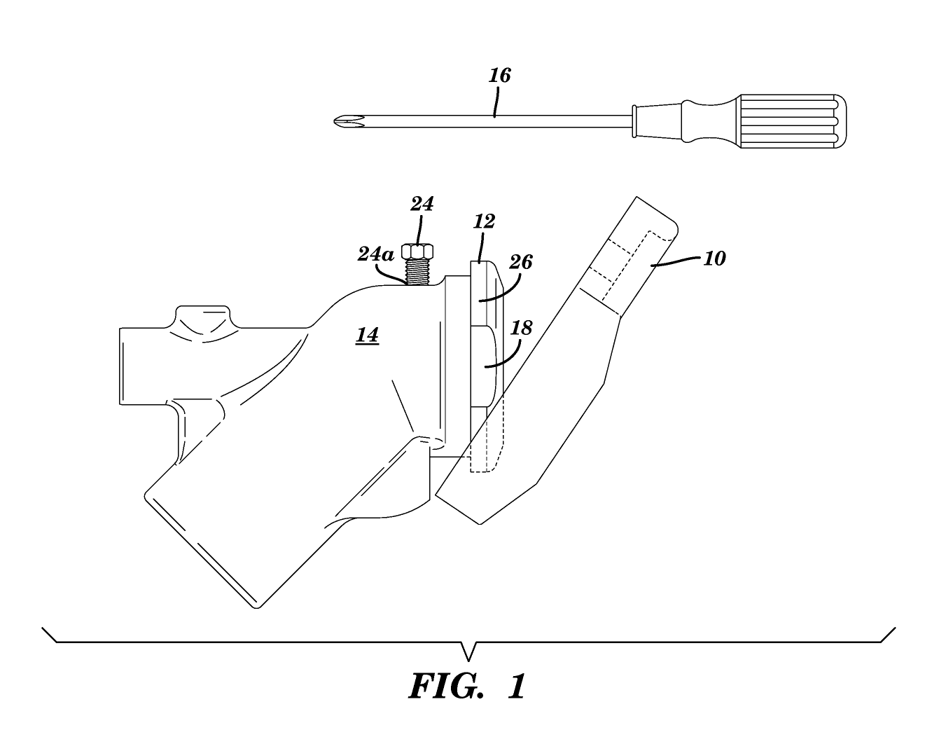

FIG. 2 shows the screwdriver being started to stretch the cap over the sprayhead.

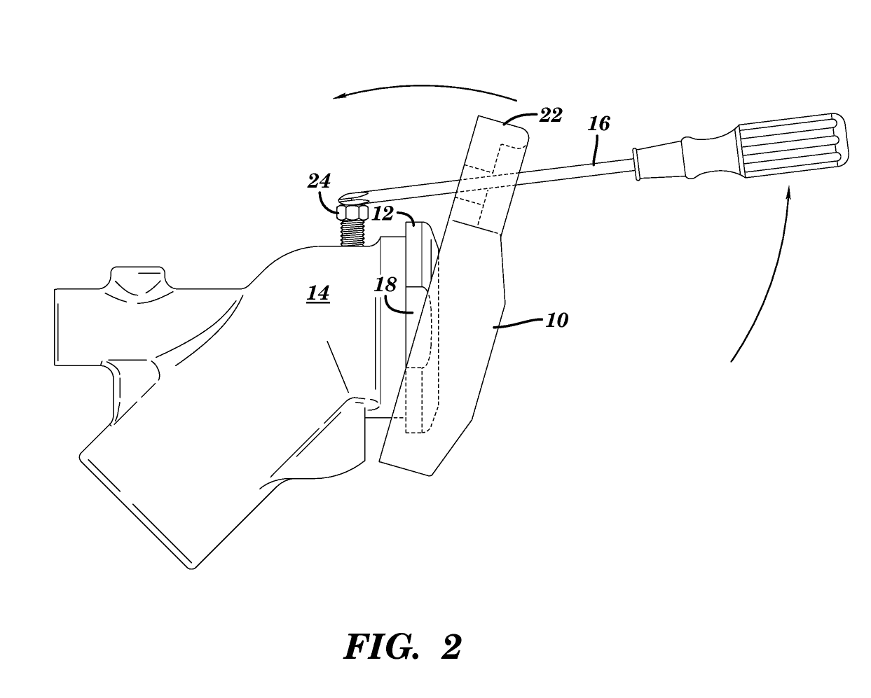

FIG. 3 shows the screwdriver further stretching the cap over the sprayhead.

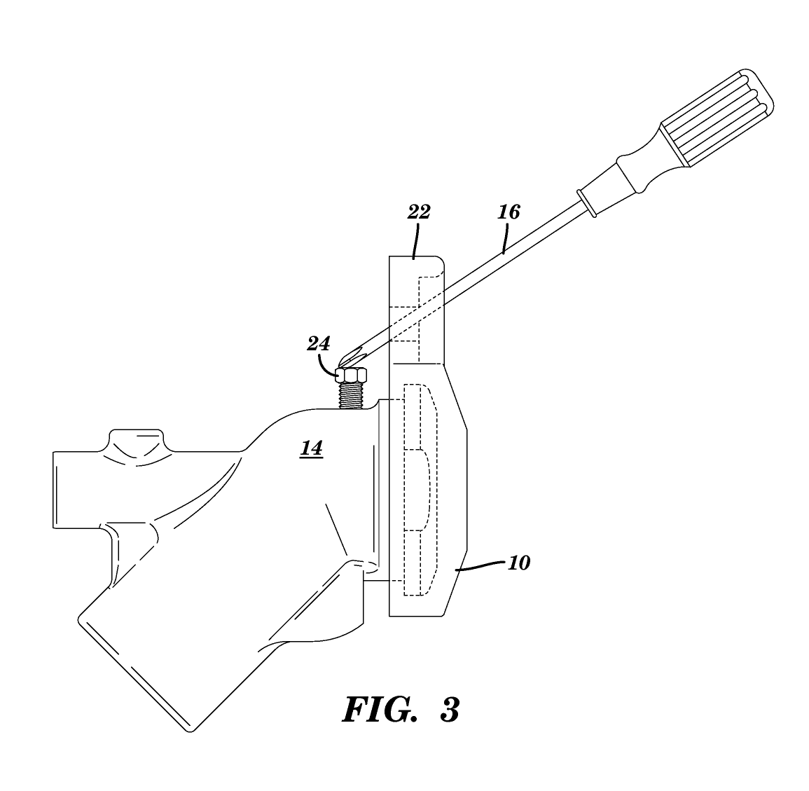

FIG. 4 shows the cap stretched over the sprayhead.

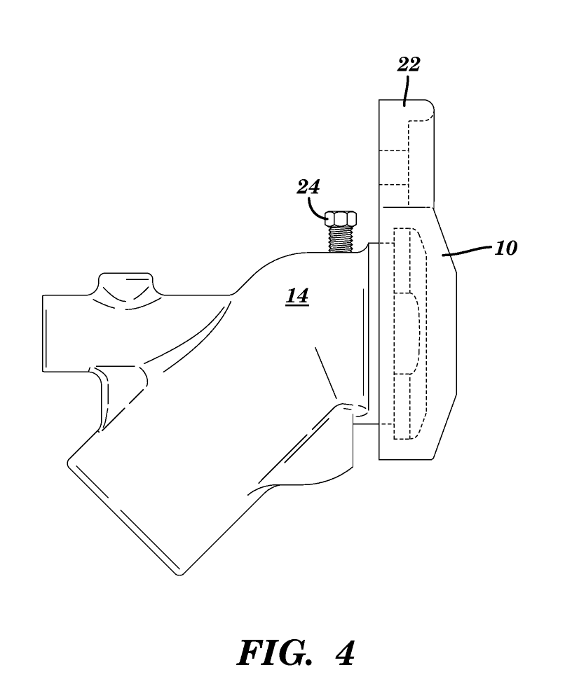

FIG. 5 shows the cap as used with the instant invention.

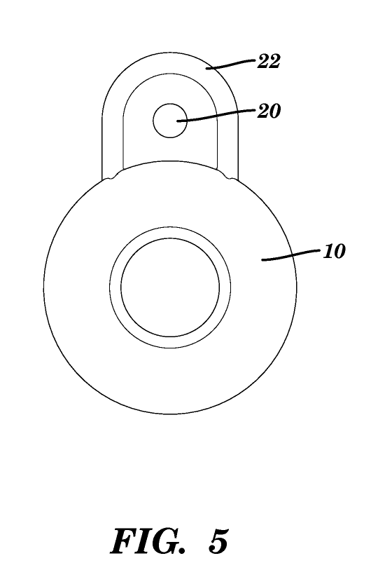

FIG. 6 shows a perspective view of the sprayhead of the instant invention.

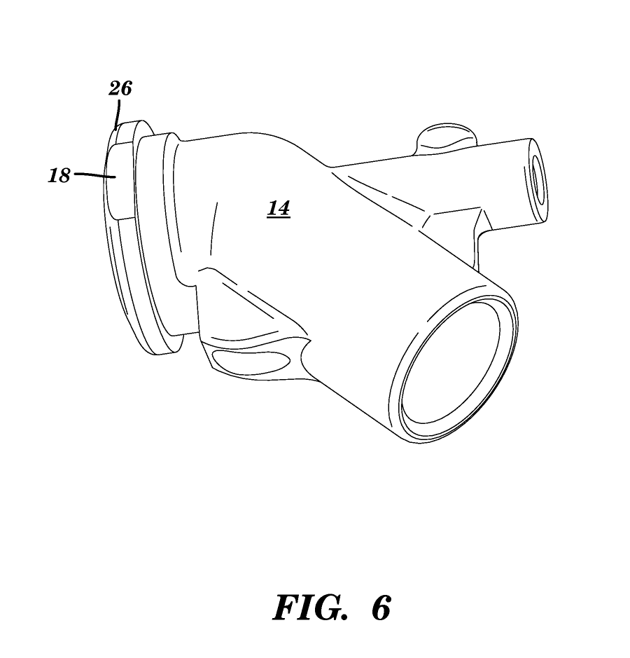

FIG. 7 shows a cross-section view of the sprayhead of the instant invention.

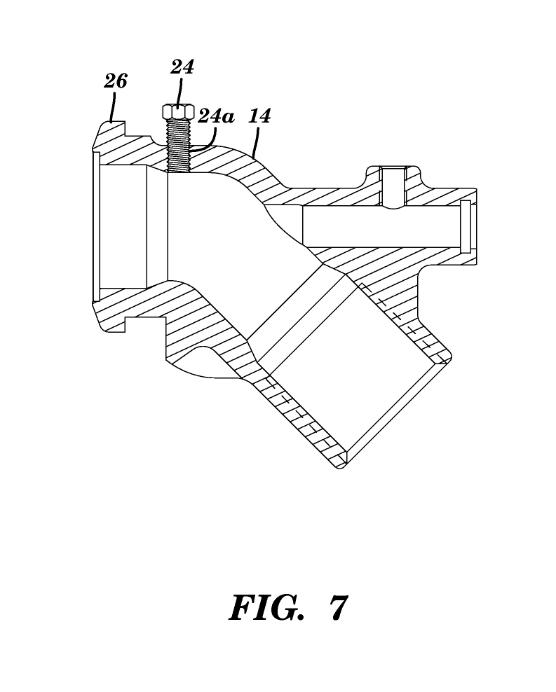

### BEST MODE FOR CARRYING OUT THE INVENTION

The instant invention significantly reduces the effort required to stretch an elastomeric nozzle retainer (cap) 10 over the retaining flanges 12 on the sprayhead 14 by providing features facilitating the use of a prying tool 16 (e.g., screwdriver) to amplify the user's effort. Flange relief flats 18 accommodate the natural, temporary inward deflection of the cap 10 during installation. The large hole 20 in the cap's tab 22, and the boss 24 on the head 14, allow the user to anchor a tool 16 on the boss 24, prying the cap 10 into place with a very significant mechanical advantage (at least 300%). A recess 24a is provided in boss 24 to locate the prying tool 16 during installation. The cap 10 is of the type sold by Nathan Kimmel and is modified by enlarging hole 20 to accommodate the prying tool 16.

The reliefs 18 on the sides of the retaining flange 26 provide clearance for the natural inwards deflection of the cap 10 during installation. This makes the sprayhead 14 appear ‘smaller’ to the cap 10 during installation, yet the remaining flange 26 still provides adequate retention once assembled. Also, the flats 18 allow the user to push the cap 10 somewhat farther onto the sprayhead when beginning the installation.

It is contemplated that various changes and modifications may be made to the retention system without departing from the spirit and scope of the invention as defined by the following claims.

1. A texture applicator having a sprayhead, said sprayhead having a generally round front end with a peripheral retaining flange, said applicator comprising:
an elastomeric nozzle retainer having a tab with a hole sized to accept a prying tool;
a boss on said sprayhead adjacent said retaining flange and located at a first circumferential position; and
at least one flange relief flat on said retaining flange, said relief flat being disposed approximately 90 degrees circumferentially from said boss.
